(19) United States
(12) Patent Application Publication
(10) Pub. No.: US 2012/0006956 A1
(43) Pub. Date: Jan. 12, 2012

(54) SHELF BRACKET

(76) Inventor: George Hofer, Hazelridge (CA)

(21) Appl. No.: 12/832,226

(22) Filed: Jul. 8, 2010

(51) Int. Cl. F16M 13/02

(52) U.S. Cl. 248/220.22

(57) ABSTRACT

A shelf bracket includes a metal rail member with two transversely spaced vertical slots and a bracket member for attachment to the rail member for extending generally outwardly from the rail member on which the shelf can rest. A pair of end tab portions of the bracket member pass through the slots with end edges at the tab portion butting against the rail member below the slot and the tab portions extending upwardly from the slot to engage the rear surface of the rail member above the slot.

This invention relates to a shelf bracket which is designed to provide improved strength between a support rail for attachment to a wall and the bracket which extends outwardly for supporting the shelf.

### BACKGROUND OF THE INVENTION

Many designs of shelf bracket have previously been provided which connect a bracket which extends outwardly from a wall to a vertical rail which provides support for the bracket so that the bracket can receive a shelf carried on the bracket.

US Published application 2002/0139808 (Grueneberg) published Oct. 3, 2002 and issued as U.S. Pat. No. 6,557,711 discloses a shelf attachment display unit which includes a tray, a hanger bracket and a placard each made from a blank of corrugated cardboard. The tray blank is folded to form front, back, bottom and end walls and the back wall has a pair of vertical slots therein. The hanger bracket is folded to form a brace extending laterally behind the back wall and having arms at its ends. The arms define channels opening in the direction of the brace and tabs extending away from the brace having upwardly opening notches for engagement with the slots in the back wall of the tray. The channels are sized to receive an edge of a shelf member and the brace is positioned to contact an underside of the shelf member when the shelf member is in the channels so as to cantilever the shelf display unit to the shelf.

### SUMMARY OF THE INVENTION

It is one object of the invention to provide an improved shelf bracket.

According to one aspect of the invention there is provided a shelf bracket comprising:

a rail member for attachment to a wall and having a rear surface facing the wall and a front surface facing away from the wall;

a bracket member for attachment to the rail member for extending generally outwardly from the rail member and the wall and including an upper surface on which the shelf can rest;

the rail member having an upstanding slot though the thickness thereof from the rear surface to the front surface for receiving an end tab portion of the bracket member passing through the slot so that a portion of the bracket member is behind the rail member for supporting the upper surface in front of the rail member;

the bracket member including a sheet with an end edge at the tab portion for butting against the rail member;

the end edge of the bracket member extending downwardly from the slot to engage the front surface of the rail member below the slot and the tab portion extending upwardly from the slot to engage the rear surface of the rail member above the slot.

It will be appreciated that the term “shelf” as used herein is intended to include other similar objects with a base to be supported on a bracket at or adjacent a wall such as a box, cabinet, or the like. Typically the rail will be elongate and be arranged for supporting additional shelves at spaced positions along the height of the rail. However this is not essential in the construction. The wall can be any vertical structure on which the shelves are to be mounted and there is intended no limitation as to the construction of the vertical surface.

Because the main pressure applied by the tab to the rear surface of the rail is located at the top of the tab which is spaced upwardly from the top of the slot, the possibility of a tear in the metal getting a start is very much reduced relative to competitive designs. In such designs, typically the bracket has the tab facing downwardly so that it hooks over the top of the slot and applies the main pressure at the top of the slot so that this design has a ready made start point at the slot for effecting a tearing action. This change in the arrangement of the tab provides a significant improvement in strength relative to such previous designs. The provision also of a 90 degree bend at this location on the tab also provides additional strength

Preferably the end edge is arranged to lie flat against the front surface of the rail below the slot with an engagement edge of the tab portion lying flat against the rear surface of the rail above the slot.

Preferably the tab portion engages the rail only above the slot.

Preferably the tab portion includes an end edge opposite the engagement edge which is generally semi-circular so as to allow the tab portion to be inserted through the slot with the bracket member extending along the rail and the bracket member pivoted downwardly to the outwardly extending position.

Preferably the engagement edge of the tab portion has a height along the rail which is substantially equal to a height of the tab portion in the slot.

Preferably the tab portion has a width extending rearwardly from the slot which is substantially equal to the height of the engagement edge of the tab portion.

Preferably the rail member includes two parallel transversely spaced slots and the bracket member includes two parallel sheets each having a tab portion.

Preferably the two parallel spaced sheets are connected by a transverse connection sheet.

Preferably the transverse connection sheet is across the bottom of the parallel spaced sheets.

Preferably the transverse connection sheet and the parallel spaced sheets are formed integrally from a single piece of sheet metal.

Preferably the top edges of the parallel spaced sheets are spaced and open and provide support for the shelf.

Preferably the parallel spaced sheets are tapered upwardly and outwardly so that the transverse connection sheet is inclined upwardly.

Preferably the parallel spaced sheets are tapered to a point at the outermost end so that the transverse connection sheet is inclined upwardly to the point.

Preferably the slots are formed at side edges of the rail so as to be flush with a 90 degree bend forming the side flanges which gives added strength to the rail at the location of the slot and reduces the possibility for the forces applied at the slot from bending or distorting the rail.

Preferably the rail includes side flanges for engaging the wall and for holding a web of the rail spaced from the wall for receiving the tab portion.

### BRIEF DESCRIPTION OF THE DRAWINGS

One embodiment of the invention will now be described in conjunction with the accompanying drawings in which:

FIG. 1 is a cross sectional view through a self bracket according to the present invention.

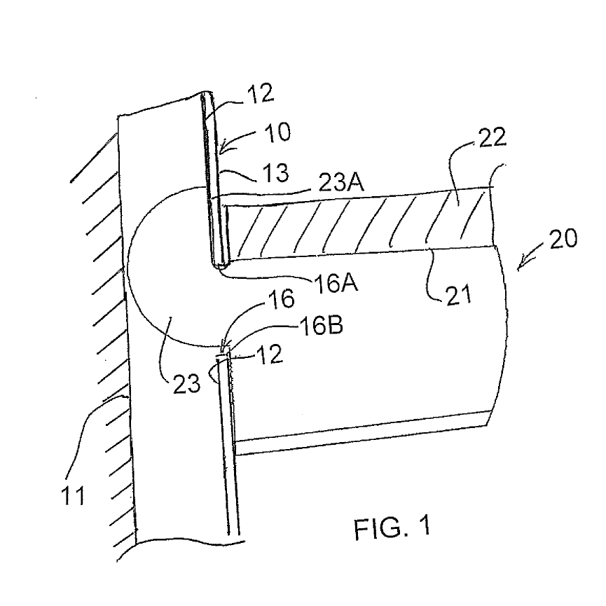

FIGS. 2 to 5 are various views of the bracket member of the embodiment of FIG. 1.

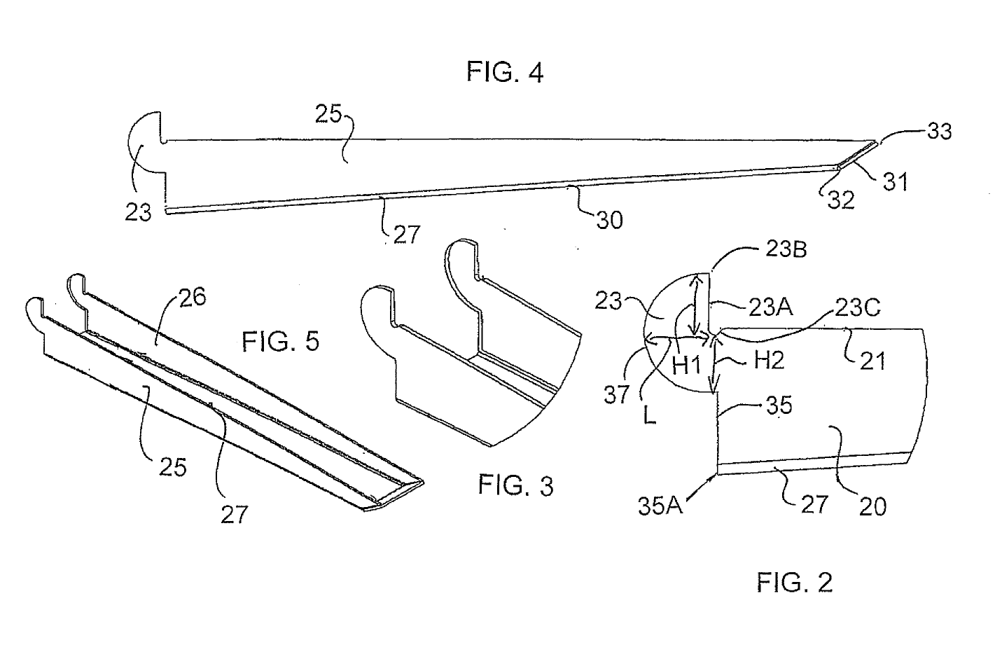

FIGS. 6 and 7 are various views of the rail member of the embodiment of FIG. 1.

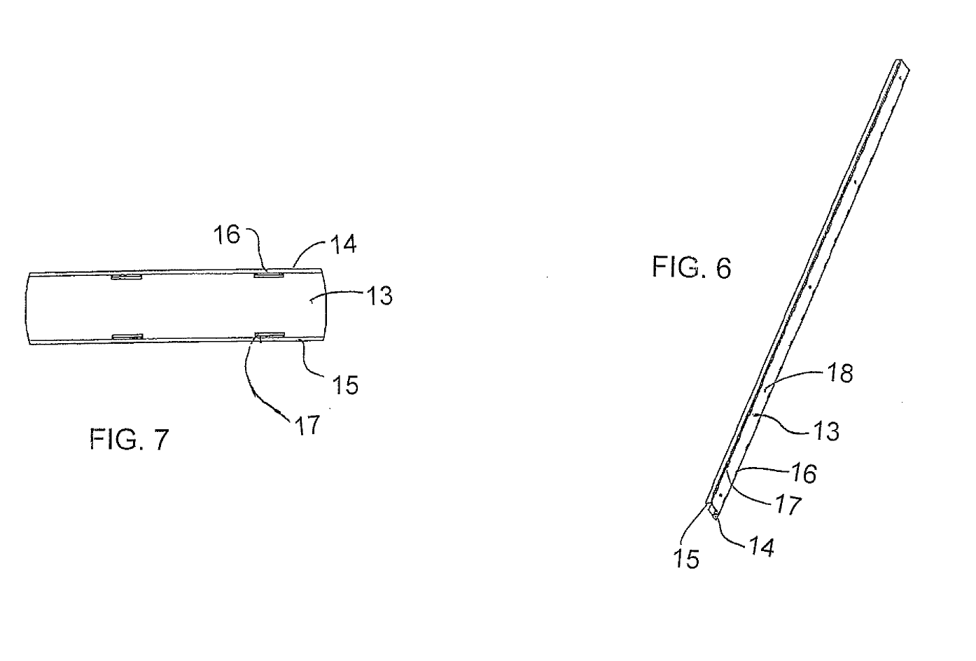

In the drawings like characters of reference indicate corresponding parts in the different figures.

### DETAILED DESCRIPTION

The shelf bracket as shown in the figures comprises a rail member 10 for attachment to a wall 11 and having a rear surface 12 facing the wall and a front surface 13 facing away from the wall. The rail is channel shaped and includes a central web 13 and two rearwardly extending side flanges 14 and 15. The web contains a series of slots arranged in pairs 16, 17 at spaced positions along the length of the rail. The rail is screwed to the wall by screws through holes 18 along a center of the web so that the rear edges of the flanges hold the web spaced from the wall to allow insert of the tabs of the bracket into the slots. The slots 16 and 17 are located directly at the sides of the rail so as to be flush with a 90 degree bend forming the side flanges 14, 15 which gives added strength to the rail at the location of the slot and reduces the possibility for the forces applied at the slot from bending or distorting the rail.

The bracket member 20 when attached to the rail member extends generally outwardly from the rail member and the wall and including an upper surface 21 on which the shelf 22 can rest. The upstanding slots 16 and 17 in the rail member 10 extend though the thickness of the web from the rear surface to the front surface for receiving an end tab portion 23 of the bracket member passing through the slot so that a portion of the bracket member is behind the web of the rail member for supporting the upper surface 21 in front of the rail member 10.

The bracket member 20 includes two parallel sheets 25 and 26 each having a tab portion 23. The two parallel spaced sheets are connected by a transverse connection sheet 27 across the bottom edges of the parallel spaced sheets 25, 26 so that the transverse connection sheet and the parallel spaced sheets are formed integrally from a single piece of sheet metal cut and formed using conventional forming techniques. The top edges 21 of the parallel spaced sheets are spaced and open and provide support for the shelf 22. The parallel spaced sheets 25, 26 are tapered upwardly and outwardly as indicated at 30 so that the transverse connection sheet 27 is inclined upwardly to an outer end 32 where the parallel spaced sheets are tapered at a sharper angle as indicated at 31 to a point 33 at the outermost end. This provides a smooth clean bottom surface of the bracket underneath the shelf which converges upwardly and outwardly to meet the bottom surface of the shelf.

Each sheet 26, 27 of the bracket member includes an end edge 35 at the tab portion 23 for butting against the rail member. Thus the end edge 35 of the bracket member extends downwardly from a bottom edge 16B of the slot to engage the front surface 13 of the rail member below the slot 16 and the tab portion 23 extending upwardly from the slot includes a front edge 23A engaging the rear surface 12 of the rail member above the upper edge 16A the slot.

The end edge 35 is arranged to lie flat against the front surface 13 of the rail below the slot 16 with the engagement edge 23A of the tab portion 23 also lying flat against the rear surface 12 of the rail above the slot 16. Thus only the tab portion 23 of the bracket engages the rail above the slot. In this way, pressure from the load on the shelf is transferred to a bigger area of the rail from the top edge 23B of the surface 23A to the bottom edge 35A of the engagement edge 35. This provides a large area of contact to transfer significant forces while reducing the possibility that the tab tears through the web of the rail. The pressure is split between the area above and the area below the slot 16.

The tab portion includes an end edge 37 opposite the engagement edge 23A which is generally semi-circular from the top edge 23B so as to allow the tab portion to be inserted through the slot with the bracket member extending along the rail and the bracket member pivoted downwardly to the outwardly extending position.

In order to allow this insertion and pivotal movement, the engagement edge 23A of the tab portion has a height H1 along the rail which is substantially equal to a height H2 of the tab portion in the slot which is substantially equal to a width L extending rearwardly from the slot.

A shallow notch 23C is provided at the junction between the edge 23A and the top surface to assist in allowing entry of the tab into the slot and to avoid the presence of a sharp corner at this junction which could promote tearing at this location which takes the major part of the load which is applied through the bracket to the tab 23.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A shelf bracket comprising:
a rail member having a front wall and two side flanges each at a respective side of the front wall and connected to the front wall by a 90 degree bend, the front wall having a rear surface and a front surface;
a shelf having a bottom surface;
a bracket member for attachment to the rail member for extending generally outwardly from the rail member and the wall and including an upper surface on which the shelf rests;
the bracket member which is generally of channel shape including two parallel spaced sheets connected across a bottom of the parallel sheets by a transverse connection sheet with spaced top edges of the parallel sheets facing upwardly and forming said upper surface so that the bottom surface of the shelf sits on the spaced top edges of the parallel sheets and is supported thereby;
the rail member having two rows of upstanding slots through the thickness of the front wall thereof from the rear surface to the front surface;
the two rows of slots each being located directly at respective sides of the rail member so as to be flush with the 90 degree bend connecting the side flanges to the front wall;
each slot of each row being arranged for receiving an end tab portion of a respective one of the parallel sheets of the bracket member passing through the respective slot so that a portion of the bracket member is behind the rail member for supporting the upper surface in front of the rail member;
each of the parallel sheets and the transverse connection sheet of the bracket member including an end edge at the tab portion butting against the front surface of the front wall of the rail member;
each of the two parallel spaced sheets of the bracket member including only a single tab portion at the top of the two parallel spaced sheets so that the whole of the end edge of the two parallel spaced sheets below the single tab portion butts against the front surface of the front wall of the rail member;
the end edges of the parallel sheets of the bracket member extending downwardly from the respective slot to engage the front surface of the front wall of the rail member below the respective slot and the end edge of the transverse connection sheet butting against the front surface of the front wall below the slots;
and the tab portion extending upwardly from the respective slot to engage the rear surface of the front wall of the rail member above the respective slot.

2. The shelf bracket according to claim 1 wherein an engagement edge of the tab portion lies flat against the rear surface of the front wall of the rail member above the slot.

3. (canceled)

4. The shelf bracket according to claim 2 wherein the tab portion includes an end edge opposite the engagement edge which is generally semi-circular so as to allow the tab portion to be inserted through the slot with the bracket member extending along the rail member and the bracket member pivoted downwardly to the outwardly extending position.

5. The shelf bracket according to claim 2 wherein the engagement edge of the tab portion has a height along the rail member which is substantially equal to a height of the tab portion in the slot.

6. The shelf bracket according to claim 5 wherein the tab portion has a width extending rearwardly from the slot which is substantially equal to the height of the engagement edge of the tab portion.

7. (canceled)

8. (canceled)

9. (canceled)

10. (canceled)

11. (canceled)

12. A shelf bracket comprising:
a rail member having a front wall and two side flanges each at a respective side of the front wall and connected to the front wall by a 90 degree bend, the front wall having a rear surface and a front surface;
a shelf having a bottom surface;
a bracket member for attachment to the rail member for extending generally outwardly from the rail member and the wall and including an upper surface on which the shelf rests;
the bracket member which is generally of channel shape including two parallel spaced sheets connected across a bottom of the parallel sheets by a transverse connection sheet with spaced top edges of the parallel sheets facing upwardly and forming said upper surface so that the bottom surface of the shelf sits on the spaced top edges of the parallel sheets and is supported thereby;
the rail member having two rows of upstanding slots through the thickness of the front wall thereof from the rear surface to the front surface;
the two rows of slots each being located directly at respective sides of the rail member so as to be flush with the 90 degree bend connecting the side flanges to the front wall;
each slot of each row being arranged for receiving an end tab portion of a respective one of the parallel sheets of the bracket member passing through the respective slot so that a portion of the bracket member is behind the rail member for supporting the upper surface in front of the rail member;
each of the parallel sheets and the transverse connection sheet of the bracket member including an end edge at the tab portion for butting against the front surface of the front wall of the rail member;
each of the two parallel spaced sheets of the bracket member including only a single tab portion at the top of the two parallel spaced sheets so that the whole of the end edge of the two parallel spaced sheets below the single tab portion butts against the front surface of the front wall of the rail member;
the end edges of the parallel sheets of the bracket member extending downwardly from the respective slot to engage the front surface of the front wall of the rail member below the respective slot and the end edge of the transverse connection sheet butting against the front surface of the front wall below the slots;
and the tab portion extending upwardly from the respective slot to engage the rear surface of the front wall of the rail member above the respective slot
wherein the parallel spaced sheets are tapered upwardly and outwardly so that the transverse connection sheet is inclined upwardly
and wherein the parallel spaced sheets are tapered to a point at the outermost end so that the transverse connection sheet is inclined upwardly to the point.

13. (canceled)

14. (canceled)

15. (canceled)
